(19) United States
(12) Patent Application Publication
(10) Pub. No.: US 2012/0286974 A1
(43) Pub. Date: Nov. 15, 2012

(54) Hit and Run Prevention and Documentation System for Vehicles

(75) Inventors: Heiko Claussen, Plainsboro, NJ (US); Meik Felser, Nurnberg (DE)

(73) Assignee: Siemens Corporation, Iselin, NJ (US)

(21) Appl. No.: 13/105,023

(22) Filed: May 11, 2011

(51) Int. Cl. G08G 1/01

(52) U.S. Cl. 340/935

(57) ABSTRACT

Systems and methods provide a vehicle hit-and-run prevention and documentation method and system that warn approaching vehicles that pose a collision threat and document the occurrence of a collision. Embodiments use vehicle proximity sensors in conjunction with vehicle video cameras to detect an approaching object, determine the likelihood of collision and if likely, record video data.

### BACKGROUND OF THE INVENTION

The invention relates generally to documenting vehicular accidents. More specifically, the invention relates to a hit-and-run prevention and documentation system.

Hit-and-run is the act of causing or contributing to a traffic accident such as colliding with another vehicle and failing to stop and identify oneself at the scene of the accident. It is considered a crime in most jurisdictions.

Hit-and-run accidents involving parked cars occur while the driver of the struck car is away from his car. Often no information about the offender is available or it is too expensive to acquire information from sources such as traffic and surveillance cameras. If witnesses were present, their information may not prove reliable about the license plate of the offender.

What is desired is a method and system that can prevent, or document a hit-and-run accident if inevitable.

### SUMMARY OF THE INVENTION

The inventors have discovered that it would be desirable to have a vehicle hit-and-run prevention and documentation method and system that warn approaching vehicles that pose a collision threat and document the occurrence of a collision. Embodiments use vehicle proximity sensors in conjunction with vehicle video cameras to detect an approaching object, determine the likelihood of collision and if likely, record video data.

One aspect of the invention provides a hit-and-run prevention and documentation method for a vehicle. Methods according to this aspect of the invention include detecting activity of an object approaching the vehicle by one or more proximity sensors located on the vehicle, calculating the distance and velocity of the approaching object from the vehicle, estimating a likelihood of the approaching object colliding with the vehicle, and if the likelihood of collision is determined to be great recording one or more video camera views where the object is likely to collide, and activating predetermined vehicle preventive actions.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is an exemplary top view of a first parked vehicle and an approaching vehicle.

FIG. 2 is an exemplary system framework.

FIG. 3 is an exemplary method.

### DETAILED DESCRIPTION

Embodiments of the invention will be described with reference to the accompanying drawing figures wherein like numbers represent like elements throughout. Before embodiments of the invention are explained in detail, it is to be understood that the invention is not limited in its application to the details of the examples set forth in the following description or illustrated in the figures. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having,” and variations thereof herein is meant to encompass the items listed thereafter and equivalents thereof as well as additional items.

The terms “connected” and “coupled” are used broadly and encompass both direct and indirect connecting, and coupling. Further, “connected” and “coupled” are not restricted to physical or mechanical connections or couplings.

It should be noted that the invention is not limited to any particular software language described or that is implied in the figures. One of ordinary skill in the art will understand that a variety of alternative software languages may be used for implementation of the invention. It should also be understood that some of the components and items are illustrated and described as if they were hardware elements, as is common practice within the art. However, one of ordinary skill in the art, and based on a reading of this detailed description, would understand that, in at least one embodiment, components in the method and system may be implemented in software or hardware.

Embodiments of the invention provide methods, system frameworks, and a computer-usable medium storing computer-readable instructions that provide a hit-and-run prevention and documentation system for parked or moving vehicles. The invention is a modular framework and is deployed as software as an application program tangibly embodied on a program storage device. The application code for execution can reside on a plurality of different types of computer readable media known to those skilled in the art.

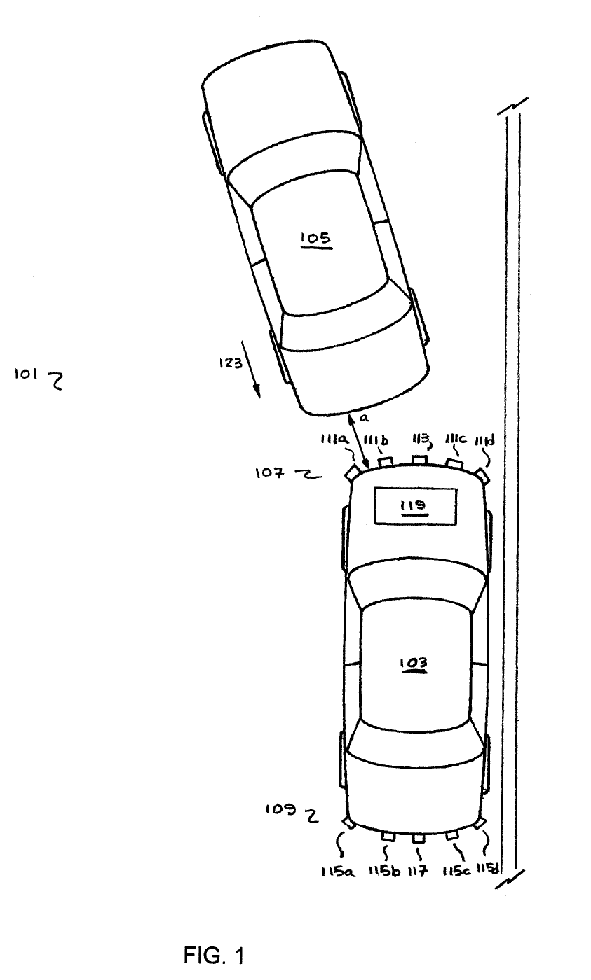

FIG. 1 shows an exemplary plan view of vehicle parallel parking 101 that involves a first (parked) vehicle 103 having installed an embodiment of the invention and an approaching (parking) vehicle 105. Embodiments comprise a vehicle front array 107 and/or a rear array 109. The front array 107 comprises a plurality of proximity sensors 111a, 111b, 111c, 111d (front, collectively 111) and one or more video cameras 113. The rear array 109 comprises a plurality of proximity sensors 115a, 115b, 115c, 115d (rear, collectively 115) and one or more video cameras 117. A processing unit 119 receives proximity and video data from the front 107 and rear 109 arrays. Embodiments may be part of, or make use of, a parking assistance system and a vehicle camera system. The proximity sensors 111, 115 may use ultrasonic or microwave energy.

Each proximity sensor 111, 115 may be an in-bumper type and emits a pulsed signal and receives a return signal reflected in their respective detecting beam cone diameter at a given distance s. Each proximity sensor 111, 115 measures the time taken for each pulse to be reflected back to its receiver and may have a detecting beam cone angle α of 80° that defines a beam cone diameter that varies with distance. A typical proximity sensor 111, 115 range may be from 30 cm to 3 m (1 to 10 ft), where the distance to an object can be reliably detected.

Depending on the number of video cameras employed, each video camera 113, 117 may include a normal, wide-angle or fish-eye lens to view faraway objects or view a horizon. Each camera may be oriented at a slight downward angle to view obstacles on the ground as well as approaching objects and capture them as moving or still images.

When an object such as the approaching vehicle 105 is detected in a proximity sensor's 111b detecting beam cone, the separation distance a between the first (parked) vehicle 103 and the approaching (parking) vehicle 105 is detected and measured. The position of the approaching vehicle 105 relative to the first vehicle 103 can be determined by using more than one proximity sensor 111a, 111b, defining individual separation distances a₁₁₁ₐ,a_{111b} from each detecting proximity sensor 111a, 111b.

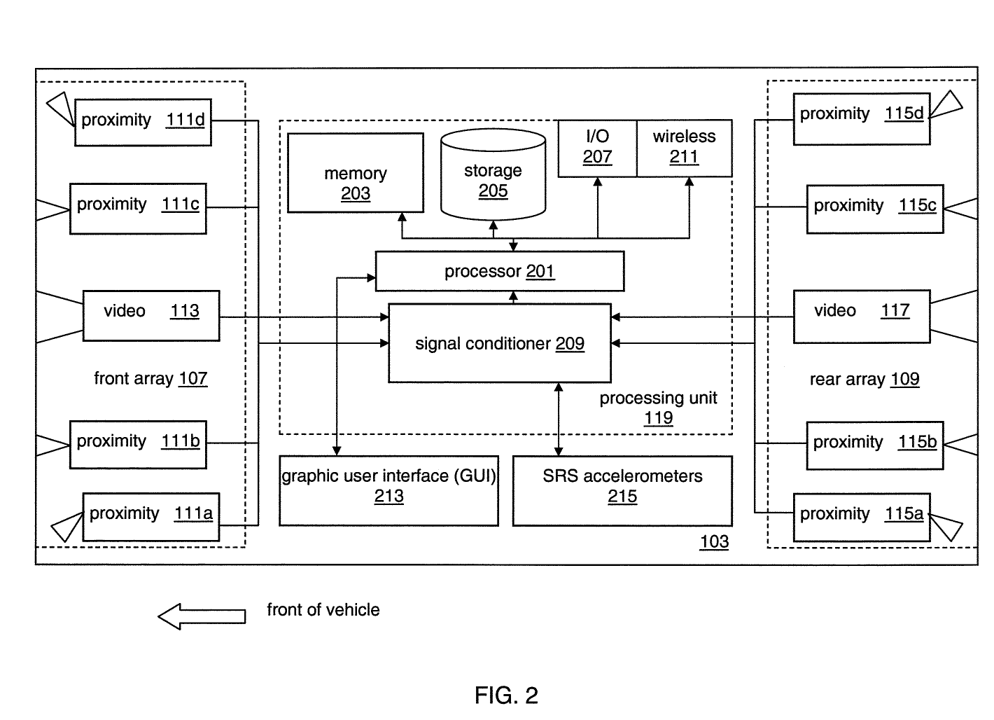

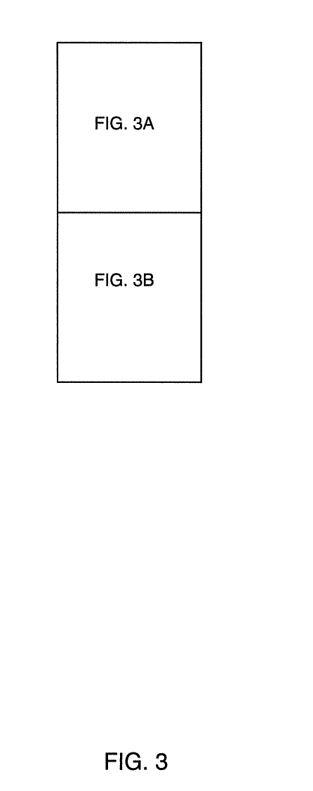

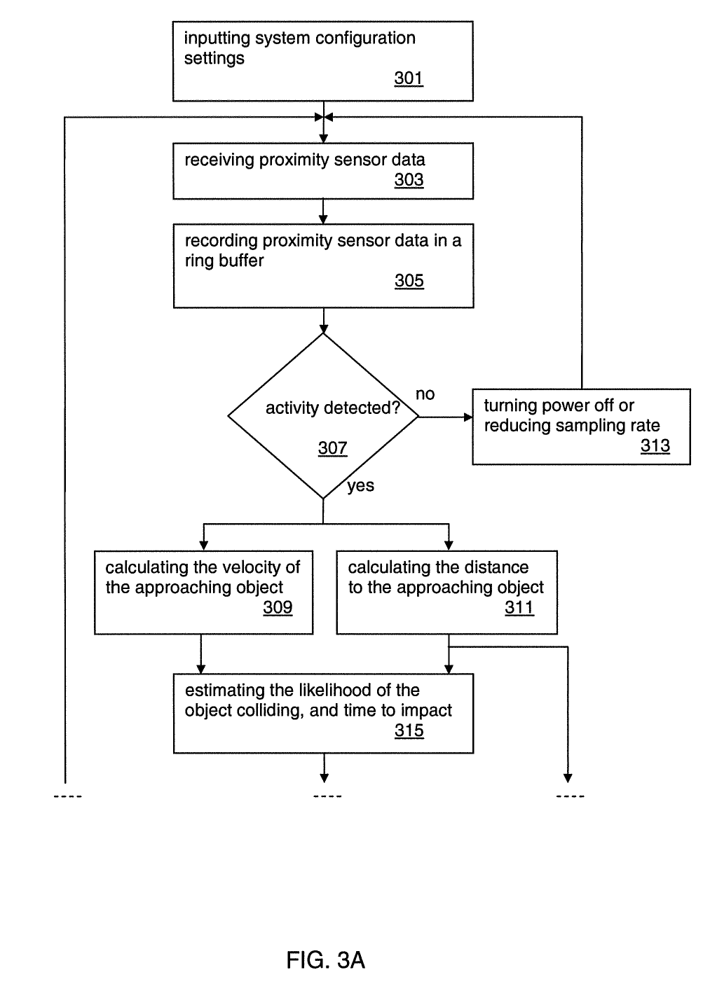

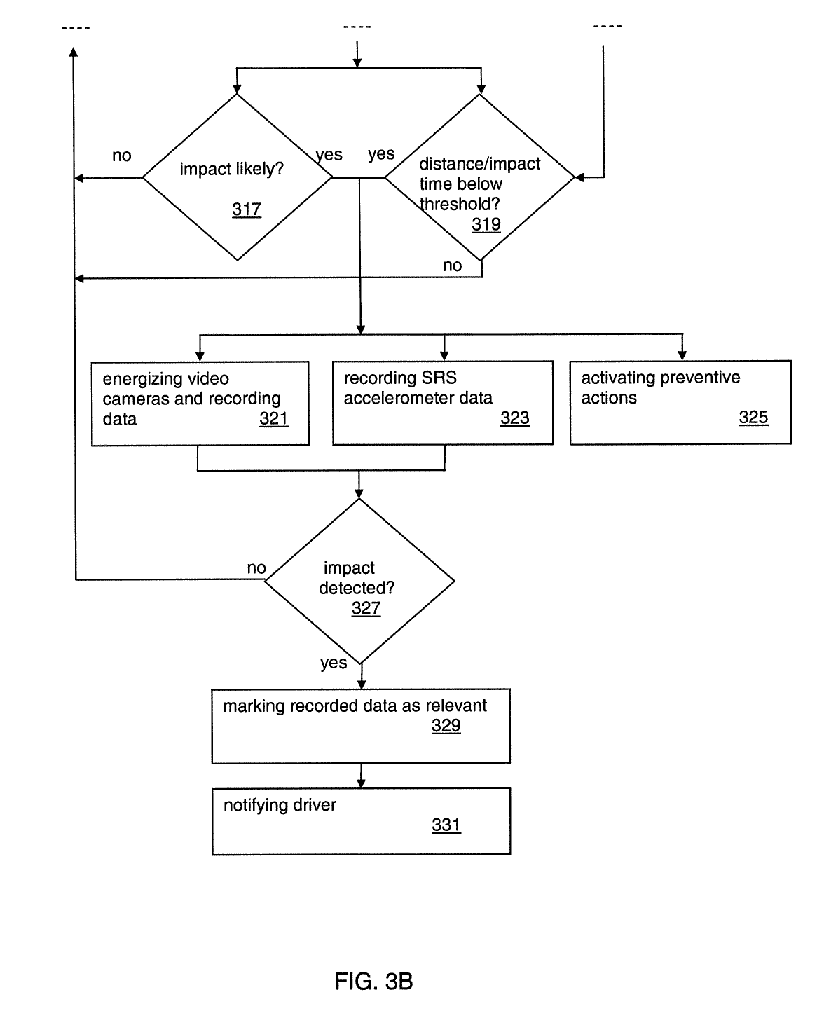

FIG. 2 shows an embodiment of the processing unit 119 and FIG. 3 shows a method. The processing unit 119 calculates the separation distance a and a velocity v of an approaching object in a proximity sensor's 111, 115 detecting beam cone. The processing unit 119 comprises a processor 201, memory 203, a data store 205, I/O 207, a signal conditioner 209 and a wireless transceiver 211. The I/O 207 may comprise Ethernet, Universal Serial Bus (USB), IEEE 1394 (FireWire) and others. The wireless transceiver 211 communicates via wireless telephony, Bluetooth and Wi-Fi.

The processor 201 is coupled to the signal conditioner 209, I/O 207, storage 205 and memory 203 and controls the overall operation by executing instructions defining the configuration. The instructions may be stored in the storage 205, for example, and downloaded from an optical or magnetic disk via the I/O 207 or transceiver 211 and loaded into the memory 203 when executing the configuration. Embodiments may be implemented as an application defined by the computer program instructions stored in the memory 203 and/or storage 205 and controlled by the processor 201 executing the computer program instructions. The I/O 207 allows for user interaction with the processing unit 119 via peripheral devices.

The processor 201 receives conditioned 209 data from the proximity sensors 111, 115 and video cameras 113, 117, and from the vehicle's 103 Supplemental Restraint System (SRS) accelerometers 215. A Graphic User Interface (GUI) 213 provides the driver with a display for system configuration and to view video camera 113, 117 images. The GUI 213 may be a multi-touch screen employing gesture-touch and shared with a vehicle navigation system.

The processor 201 timestamps the data output from the proximity sensors 111, 115, videos cameras 113, 117 and SRS accelerometers 213 to provide real-time data logging when elements of the system are activated. Results and acquired data are stored in the data storage 205 and may be uploaded to another device (not shown) via I/O 207 or transceiver 211 for additional analysis.

FIG. 1 shows the approaching vehicle 105 attempting to parallel park in front of the first (parked) vehicle 103 which is unoccupied. When the approaching vehicle 105 moves in the direction of the arrow 123 at velocity v, the respective instantaneous separation a from the first vehicle 103 can be calculated by the proximity sensors 111 when in range.

Prior to operation, a driver inputs system configuration settings using the GUI 213 (step 301). System settings are stored in the data store 205 and may include system “on” or “off” for when the vehicle is parked, system “on” or “off” for when the vehicle is moving (thresholds and battery conservation settings are different for this aspect since there is no problem with power but the system has to work reliably for potentially higher speed differences), select an operating time after the vehicle engine is turned off (parked) (e.g., two days), select an event data for export via the I/O 207 or transceiver 211, select hit-and-run preventative measures such as sounding the vehicle's 103 horn, flashing the hazard lights, or backing up if the vehicle is enabled with an intelligent parking assist system, select vehicle-to-vehicle communication to inform the approaching car if it is capable of processing such communication, and select means by which the vehicle sends an alert message (text, Multimedia Messaging Service (MMS)) to the driver if a collision event occurs.

Power consumption can also be reduced by lowering the sampling rate of the proximity sensors. Thus, the processor 201 analyzes less data. The sampling frequency affects at which speed an approaching object can be detected before impact. For example, if the sampling frequency is set at 1 sample/s and another vehicle approaches at 10 km/h, the system would measure its distance at a resolution of 2.78 m. This low sampling frequency is insufficient for a sensor range of 2.7 m and 10 km/h or more for the approaching vehicle. Reasonable sampling frequencies to detect approaching objects with a speed of 30 km/h are between 100 Hz to 1 kHz which enables the system to operate with a resolution of approximately 8.3 cm to 8.3 mm. This ensures an early detection and increases the time for the approaching vehicle to react on the audio visual warning signals.

Embodiments can be used when the vehicle is parked or moving. As an accident is often traumatic for the driver, they generally cannot reliably remember the license number plate or the chain of events of the accident. Embodiments provide documentation and confirm what happened.

During operation, proximity sensor data 111, 115 in the form of distance measurements is acquired at a nominal sampling rate of approximately 1 kHz and recorded in a ring buffer 205 that overwrites old data with newly acquired data. This limits the amount of storage 205 without data loss (steps 303, 305). When one sensor 111b is used in conjunction with another sensor 111a in an array 107, a proximity view for the vehicle is created from the individual measurement relative arrival times to each sensor.

The individual measured proximity data 111 is combined to estimate the direction of the approaching object 105 over time. Inverse triangulation can be used to derive a relative position of the approaching object 105 from the distance data a₁₁₁ₐ,a_{111b} of several sensors 111a, 111b. The change of the position over time can then result in relative vectors for speed and acceleration in two dimensions (2D) that can be used for a more accurate estimation of the probability for an impact. Embodiments can distinguish if a vehicle 105 is approaching at a fixed angle of, for example, 45° with respect to the vehicle's 103 longitudinal axis and if the vehicle 105 reduces its speed 123 or it approaches with constant speed and changes the angle to, for example, 10°. In contrast, a prior art parking assistant system uses only the closest distance of the sensor array. In this way it can only assess the movement of the closest point but not of the whole vehicle.

A detected object's signal is passed through the signal conditioner 211 and a front 107 or rear 109 proximity view is created by the processor 201 which localizes and classifies an object as approaching and measures its velocity. The vehicle 103 therefore knows which direction an object is approaching from, its velocity, and where the object is relative to the vehicle 103 body.

If an object is not detected for a time longer than the user defined threshold and the car engine is off, the system powers down (steps 307, 313). Alternatively, the system reduces the sampling frequency to its user defined lower bound if no activity is detected for a user defined period of time. If an object is detected and is determined to be approaching, the processor 201 increases the sampling rate of the proximity sensors 111, 115 and calculates the object's velocity and distance (position) from the vehicle 103 (steps 307, 309, 311). Using the approaching object's velocity and distance, the processor 201 estimates whether the object presents a likelihood of collision, and if so, when the collision is expected (step 315).

The estimate of a likelihood of collision is computed as follows. Let S_{B}, t_{R}, f_{DF}, v and

$$g = 9.81 \frac{m}{{s}^{2}}$$

represent breaking distance, reaction time, dynamic friction, speed of the approaching vehicle 105 and gravitational acceleration respectively. The breaking distance S_{B} is

$${s}_{B} = \frac{{v}^{2`}}{2 {f}_{DF} g} . \qquad ( 1 )$$

f_{DF}=0.5 can be assumed for a dry road surface. The total distance until the vehicle stops s_{T} can be computed as the breaking distance s_{B} plus a reaction distance s_{R} assuming that the driver of the approaching vehicle 105 recognizes the danger of the situation at the current time

s_{T}=s_{B}+s_{R}. (2)

The reaction distance s_{R} can be computed as

s_{R}=t_{R}v. (3)

If there is a distance s₁ until impact between both vehicles, the driver has

$${t}_{RI} = \frac{{S}_{1} - {S}_{B}}{v} \qquad ( 4 )$$

time to react before it is physically impossible to prevent a collision. The likelihood of a collision equals the likelihood that the driver reacts within reaction time t_{RI}.

This “choice reaction time t_{RI}” has been analyzed in many psychological experiments and the experimentally found distributions can be used as a reliable measure of collision probability. The choice reaction time t_{RI} may be modeled as a Gaussian distribution with a mean μ=0.4 s and a variance σ=0.2 s. The probability of an impact p_{I} is

$${p}_{I} = 0.5 - erf ( \frac{\frac{{S}_{I} - {S}_{B}}{v} - μ}{\sqrt{2 {σ}^{2}}} ) , \qquad ( 5 )$$

where erf represents the error function. Note that s_{I} is defined as the closest point distance between both vehicles 103, 105 in the direction of the velocity v 123 of the approaching vehicle 105 (FIG. 1).

If the approaching object is determined not to be on a collision course (step 317), the system waits until another object is detected and the previous proximity sensor data 111, 115 recorded in the ring buffer 205 is overwritten with new data. If the approaching object is determined to be on a collision course, the video cameras 113, 117 are energized, and their data, SRS accelerometer data 215, and calculated approaching object velocity v is recorded (steps 321, 323).

Driver selected preventive measures, such as hazard warning lights and/or horn are initiated to alert the approaching object/vehicle's driver (step 325). Even though the estimation 315 predicts a collision, there may still be time to preventive the collision if the approaching vehicle driver brakes or performs an avoidance maneuver.

Another preventive action may involve the first vehicle 103 automatically moving from the approaching vehicle 105. This action would be an adjunct of an intelligent parking assist/guidance system. For example, if the first vehicle 103 is parked curbside (FIG. 1) and does have an intelligent parking assist/guidance system installed and the distance to the approaching vehicle 105 is below a predefined distance, the intelligent parking system is activated. The system checks whether available space exists behind the first vehicle 103 to slowly back up a few centimeters (inches) and proceeds if possible. It is important to limit the automatic backup distance to prevent parking violations or to maintain enough space for leaving the parking space.

If the distance to impact time is not below a threshold (step 319) and an impact is not likely (step 317), the system waits until another object is detected. If the distance to impact time is below the threshold, the video camera 113, 117 data and SRS accelerometer data 215 is recorded (steps 321, 323) in conjunction with preventive measures (step 325). The threshold is a combination of the camera 113, 117 activation time and view. The threshold is set such that the camera can still record and the velocity, acceleration and distance to the other object result in a high likelihood of an impact. Note that step 317 is not sufficient as there is the possibility that the approaching car drives slowly closer such that an impact is not likely until a very short distance. If the distance is too close, the camera can no longer record a focused image or meaningful picture of the approaching car. However, if the driver does not pay attention, it is still possible that an impact occurs. Therefore, it is important that the camera records “just in case” as long as there is still the possibility for it. The video is stored until the other car leaves again the close proximity.

If the first vehicle 103 is struck, the collision will be detected by the SRS accelerometers 215. Any previously recorded data for the event is marked as relevant and not written over 205 (steps 327, 329). Data from the SRS accelerometers 215 can be used to document and confirm that an impact took place and the video camera data 113, 117 images provides important information about the course of the event and details about the approaching vehicle 105 such as license plate, color and make. The driver may be notified by pre-selected means (step 331). The recorded event data may be indicated to the driver via the GUI 213, or text or MMS message. The recorded data may be viewed on the GUI 213 or uploaded 207, 211 to another device/computer.

One or more embodiments of the present invention have been described. Nevertheless, it will be understood that various modifications may be made without departing from the spirit and scope of the invention. Accordingly, other embodiments are within the scope of the following claims.

What is claimed is:

1. A hit-and-run prevention and documentation method for a vehicle comprising:
detecting activity of an object approaching the vehicle by one or more proximity sensors located on the vehicle;
calculating the distance and velocity of the approaching object from the vehicle;
estimating a likelihood of the approaching object colliding with the vehicle; and
if the likelihood of collision is determined to be great:
recording one or more video camera views located where the object is likely to collide; and
activating predetermined vehicle preventive actions.

2. The method according to claim 1 further comprising monitoring the velocity of the approaching object.

3. The method according to claim 2 wherein if the likelihood of collision is determined to be great, further comprising monitoring vehicle Supplemental Restraint System (SRS) accelerometer data.

4. The method according to claim 1 wherein predetermined vehicle preventive actions comprise the vehicle's hazard warning lights and/or horn.

5. The method according to claim 3 further comprising if the SRS accelerometer data indicates that a collision occurred, marking the recorded video camera, SRS accelerometer and approaching object's velocity data as relevant.

6. The method according to claim 3 further comprising if the SRS accelerometer data indicates that a collision occurred, notifying the driver of the vehicle.

7. The method according to claim 6 wherein notifying the driver of the vehicle further comprises sending a text, Multimedia Messaging Service (MMS), or email message to the telephone or email account of the vehicle's driver.

8. The method according to claim 1 further comprising if no activity is detected by the one or more proximity sensors, reducing the sampling frequency of the one or more proximity sensors.

9. The method according to claim 1 further comprising if no activity is detected by the one or more proximity sensors, turning the power off for the one or more proximity sensors.

10. The method according to claim 1 wherein estimating a likelihood of the object colliding with the vehicle equals the likelihood that the driver reacts within a choice reaction time t_{RI}.

11. The method according to claim 1 wherein if two or more proximity sensors detect activity, further comprising calculating the approaching object's direction/path with respect to the vehicle's longitudinal axis.

12. A hit-and-run prevention and documentation system for a vehicle comprising:
means for detecting activity of an object approaching the vehicle by one or more proximity sensors located on the vehicle;
means for calculating the distance and velocity of the approaching object from the vehicle;
means for estimating a likelihood of the approaching object colliding with the vehicle; and
if the likelihood of collision is determined to be great:
means for recording one or more video camera views located where the object is likely to collide; and
means for activating predetermined vehicle preventive actions.

13. The system according to claim 12 further comprising means for monitoring the velocity of the approaching object.

14. The system according to claim 13 wherein if the likelihood of collision is determined to be great, further comprising means for monitoring vehicle Supplemental Restraint System (SRS) accelerometer data.

15. The system according to claim 12 wherein predetermined vehicle preventive actions comprise the vehicle's hazard warning lights and/or horn.

16. The system according to claim 14 further comprising if the SRS accelerometer data indicates that a collision occurred, means for marking the recorded video camera, SRS accelerometer and approaching object's velocity data as relevant.

17. The system according to claim 14 further comprising if the SRS accelerometer data indicates that a collision occurred, means for notifying the driver of the vehicle.

18. The system according to claim 17 wherein means for notifying the driver of the vehicle further comprises means for sending a text, Multimedia Messaging Service (MMS) or email message to the telephone or email account of the vehicle's driver.

19. The system according to claim 12 further comprising if no activity is detected by the one or more proximity sensors, means for reducing the sampling frequency of the one or more proximity sensors.

20. The system according to claim 12 further comprising if no activity is detected by the one or more proximity sensors, means for turning the power off for the one or more proximity sensors.

21. The system according to claim 12 wherein means for estimating a likelihood of the object colliding with the vehicle equals the likelihood that the driver reacts within a choice reaction time t_{RI}.

22. The system according to claim 12 wherein if two or more proximity sensors detect activity, further comprising means for calculating the approaching object's direction/path with respect to the vehicle's longitudinal axis.
